(19) United States
(12) Patent Application Publication
(10) Pub. No.: US 2005/0018323 A1
(43) Pub. Date: Jan. 27, 2005

(54) Apparatus and method for a vehicular viewing system

(76) Inventor: Eileen Breslin, New Hyde Park, NY (US)

Correspondence Address: JASPAN SCHLESINGER HOFFMAN LLP, 300 Garden City Plaza, Garden City, NY, 11530, US

(21) Appl. No.: 10/626,347

(22) Filed: Jul. 24, 2003

(51) Int. Cl. G02B 5/08

(52) U.S. Cl. 359/854; 359/866

(57) ABSTRACT

A seclectably adjustable mirror is mounted on each of the extreme sides of said vehicle, preferably on the fenders. The mirrors having sight lines parallel to said front transverse axis, the sight lines extending beyond the side exterior of said vehicle and means for selectively adjusting the mirrors so as to provide sight perspectives between said aligned mirrors at the sides of the front end of said vehicle and said driver whereby said driver is provided with an enhanced exterior view while driving, capable of viewing the area ahead of and beyond the sides of said vehicle. Preferable this system is augmented by a central array of a V-shaped assembly which enlarges the sight fully.

The present invention relates to an system for enhancing the view of a driver negotiating corner intersections and roadside obstacles.

### BACKGROUND OF INVENTION

Driving in congested areas can present many hazards. Among them is a need to see the traffic flow at an intersection and around obstacles positioned beside or abeam the roadway which obscure the visibility of moving traffic. Obstacles that can preclude visibility a beam the vehicle include other larger automobiles or trucks, snow piles or snow banks abutting the road, commercial refuse containers, curbside trees and buildings. This most commonly occurs when a vehicle reaches a perpendicular intersection, intent on making a turn or continuing straight through the intersection. Thus, the driver is frequently required to slowly move the front portion of the vehicle into the stream of the perpendicular or transverse traffic flow to obtain a better view of the oncoming traffic, clearly placing the vehicle in harm's way.

U.S. Pat. No. 6,059,418 to Edwards describes an arrangement of mirrors positioned respectively on the sides of the vehicle to provide a view generally parallel to the longitudinal axis of the vehicle and around obstacles directly in front of the vehicle when the vehicle is parallel parked. The mirror system includes a first pair of mirrors positioned forward of the driver and on the outer side of the vehicle. The mirrors are oriented to reflect the view from the front of the driver rearward. Edwards is limited by providing only a view around objects where the forward view of the driver is blocked.

In U.S. Pat. No. 6,485,156 B1 to Marshall, a device is mounted on the trunk lid or tailgate, so that a person standing at the rear of the vehicle and facing towards the front of the vehicle may see to their rear. The viewing device thus functions as a potential warning device for someone against persons or vehicles approaching from behind. Marshall, is thus limited in its scope to viewing when the trunk or tailgate is opened and the vehicle is not in operation.

Notwithstanding the various attempts made by the prior art, a continuing need exists for a system to enable the device to have a wider view of roadway traffic forward of the driver and possible obstacles in the roadway while driving.

### BRIEF SUMMARY OF THE INVENTION

According to the present invention, a system is provided enhancing the view of the driver comprising a plurality of sight sensors, such as mirrors mounted on the vehicle along a transverse axis at the front end. The sensors detect the roadway conditions, exterior of the side of the vehicle and are set as so to be capable of reflecting the sight along a path directly to the driver. To further enhance the system a V-shaped sensor assembly mounted in alignment with the central axis of the vehicle may also be provided to enable the driver to view conditions abeam of the vehicles but somewhat to his rear. In addition, the system is augmented by an arrangement of rear view sensors, so as to give the driver simultaneous ability to see behind the vehicle.

Preferably, the sensors are mirrors although other sensors such as video cameras, solid state receivers and the like may be used. The sensors are adjustable to transmit the reflective or sight vectors directly to the sight area of the driver, so that he can see a wider than normal area of visibility.

The invention, together with attendant advantages, will be best understood by reference to the following detailed description of the invention when used in conjunction with the attached figures.

### BRIEF DESCRIPTION OF THE DRAWINGS

In the drawings:

FIG. 1 is a plan view of a conventional vehicle;

FIG. 2 is a view similar to FIG. 1, showing the system of the present invention;

FIG. 3 is a view similar to FIG. 1 or 2 showing one augmentation of the invention system; and

FIG. 4 is another view similar to FIG. 1 or 2 showing a second augmentation of the invention.

### DESCRIPTION OF THE INVENTION

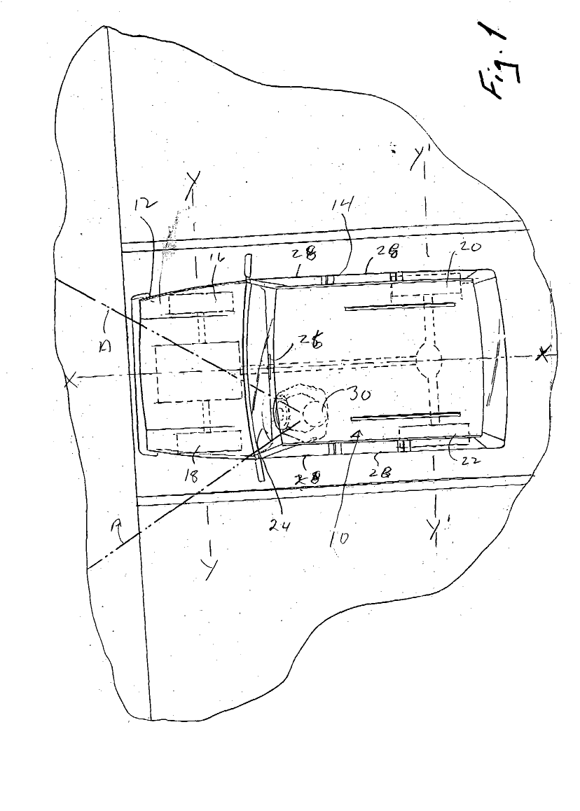

In FIG. 1, a conventional vehicle such as an automobile 10 is illustrated. Briefly, the automobile 10 has a chassis 12 (only partially shown) defining a longitudinal axis X and front and rear transverse axes Y and Y₁. The chassis 12, covered by a body 14, mounts the motor, transmission and other operating elements while it is, itself, supported above the ground by at least two pair of wheels 16 and 18 and 20 and 22. The front wheels 16 and 18, aligned along the front transverse axis Y, are turnable, in a radius of about 30-60°, so that the automobile can be steered around corners and other obstacles. The rear wheels are aligned with the rear transverse axis Y¹. The body 14 is provided with a front windshield 24 on the rear of which may be mounted the conventional interior rear view mirror 25. The vehicles body sides are formed of front and rear door panels 26 provided with a glass window surround. Located within the body 14 are the seat for the driver 30 (in American style cars, on the left side) and the passenger seats (on the right side and behind the driver).

Although a standard passenger automobile is depicted, it will be obvious that the present invention can be employed on trucks, buses and nearly all land vehicles.

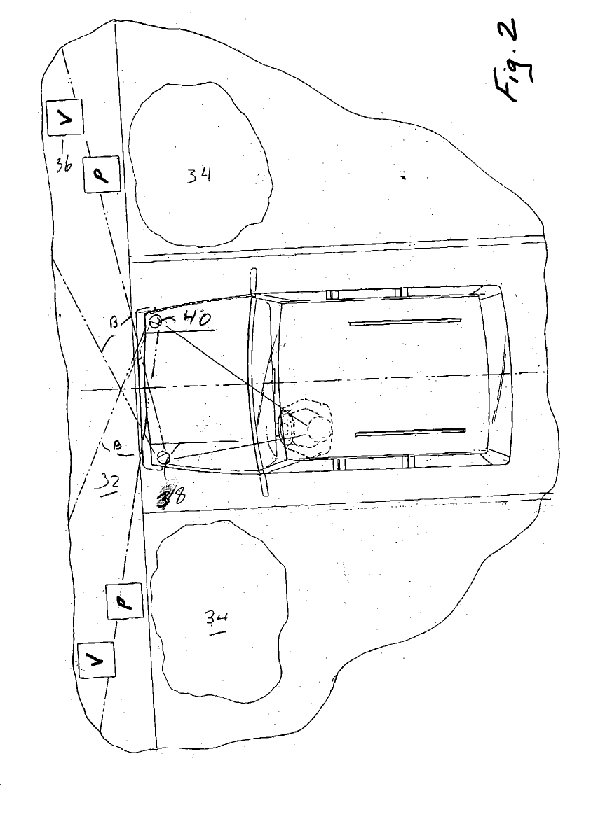

From the foregoing, it will be clear that the normal view of the driver 30 lies within an arc A, defined by the driver's peripheral vision (this is sometimes called the normal perspective). The driver's arc of vision A is less that 90° which presents a decided disadvantage and hazard as the vehicle moves past, as seen in FIG. 2, a heavily trafficked intersection 32 both parked vehicles along the curb or large roadside obstacles 34 such as a projecting building, overgrown trees, snow bank or another vehicle which obstructs the lateral view of the driver 30. In this condition, the driver's normal perspective may be so obscured that he has great difficulty or is even unable to move around the corner or see moving vehicles 36 in the intersecting street. To insure himself a sufficient degree of safety, the driver 30 normally must slow to a stop and inch forward for a better view; actually placing the vehicle in harms way as he does so. Furthermore, the driver 30 tends to bend his body and tilt his head in an attempt to see around the corner of the obstacle 34. Such maneuvers are in vain and may even be hazardous.

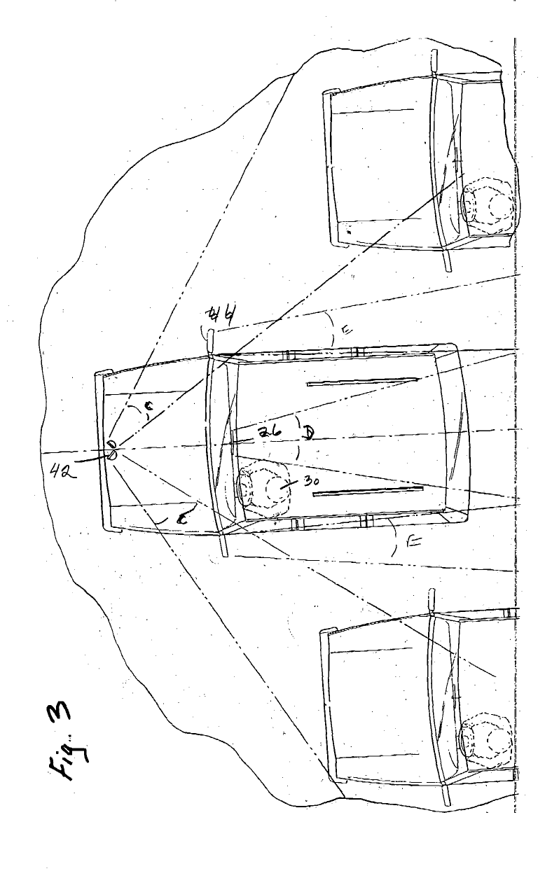

The present invention is provided with an system to enhance his normal perspective, so that the driver will be able to more easily view the road 32 and lateral obstacles 34 in front on the vehicle 10. FIG. 3, schematically shows an enhancement of the arrangement of FIG. 2 the vehicle or automobile of FIG. 1 is here also provided with a V shaped mirror array 42 mounted on the exterior surface of the hood 44. The V-shaped mirror array 42 is mounted along the central longitudinal axis X, so that the apex of the V-shape points to the rear of the vehicle 10. Each mirror of the assembly 42 is adjustable preferably remotely by the driver 30, via electrical motors and/or mechanical linkage.

As seen in FIG. 2, mounted at the front of the vehicle parallel to the Y axis are a pair of mirrors 38 and 40. Preferably these mirrors 38 and 40 are mounted on the left and right front fenders as far forward as possible. The mirrors 38 and 40 are planar also either may be curved or parabolic to enhance its sight lines and both mirrors are rotatable about perpendicular axis, via operation of the driver, by motor or mechanical linkage, so that they are selectively swingable. The mirrors 38 and 40 have a limited arc of view (perspective arc β) but being located at the foremost point of the fender has a substantially greater lateral view, in front of the vehicle than the driver's normal perspective. Since the mirrors 38 and 40 are on the vehicle, the driver's view of the mirrors 38 and 40 is relatively short, so that the need not bend his head to easily concentrate on either mirror 38 or mirror 40. Thus, the combination of the normal and the second perspective β produce a view for the driver which bends around the front of the vehicle so that the driver can “see: the intersecting street 32.

FIG. 3, schematically shows an enhancement of the arrangement of FIG. 2 the vehicle or automobile of FIG. 1 is here also provided with a V shaped mirror array 42 mounted on the exterior surface of the hood 44. The V-shaped mirror array 42 is mounted along the central longitudinal axis X, so that the apex of the V-shape points to the rear of the vehicle 10. Each mirror of the assembly 42 is adjustable preferably remotely by the driver 30, via electrical motors and/or mechanical linkage. The mirrors of array 42 are preferably convex and have limited arcs of view (perspective C). Thus the driver can effortly see-each mirror of the array 42. Perspective C each-view over the hood, rearwardly to the rear and abeam of each side of the vehicle. Perspective C views and sights along the adjacent lanes of traffic see the vehicle coming up fast on either side of the driver.

It will be seen from FIG. 3 that the foregoing view obtained from perspective C is impossible using the conventional rear view mirror 26 since the perspective arc D of the mirror only sees out of the rear view windshield. Similarly, the conventional mirror 44 placed on the outside of the panels of the vehicle have an even more limited or perspective line E, which can not see abeam vehicles.

As is apparent, the optical system comprising the V-shaped mirror assembly 38 and the fender mirrors 40 and 42, respectively, form reflective vectors, which have complex sight lines “seeing” over each of the fenders to the side and front of the vehicle. These complex sight lines, augmented by the convex mirror 42 which is capable of a wide visibility that the normal arc of the driver's sight is so broadened that he is capable of seeing into the intersection 32 and around the obstacles 34. Thus, as seen from the foregoing description and the drawings, the driver's sight area is substantially increased and his/her peripheral lines of sights so widened that he/she is capable of seeing around the obstacle that would normally hinder and delay his driving forward.

Frequently, it is necessary to “see” around corners and/or obstacles to the rear of the vehicle, as when backing out of a drive way, a parking space or moving from one street to another. In this instance, there is also provided an assembly to assist the driver, by increasing his rear visibility without the need for twisting or turning. In the uppermost and rearmost corners on each side of the vehicle is mounted a mirror 46 and 48 angled to view the opposite side of the vehicle. Each of the mirrors 46 and 48 have a limited cross view (perspective F) which lies within the perspective E created by the panels mirror 44 as well as lying in the perspective D of the normal rearview mirror 26. Mirrors 46.and 48 are like the other mirrors, adjustable thereby enabling the rearward and side extent to be adjustable to fit the driver.

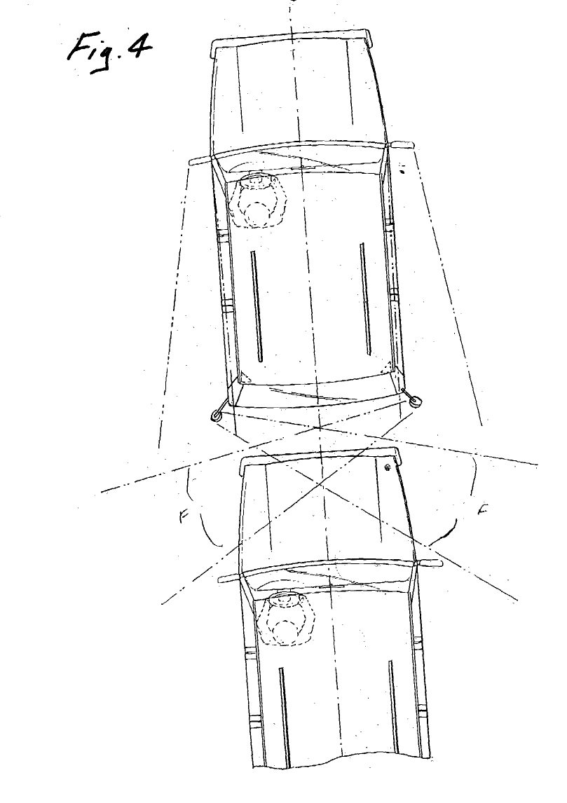

Accordingly, as seen in FIG. 4, a rear view mirror 50 and 52 is placed on the exterior of the body 14 along each side, respectively. These mirrors 50 and 52 are mounted just forwardly of the driver, on each of the equivalent door panels just below the window surround 28. The mirrors 50 and 52 may be similar to the conventional rear view mirror which has a very limited range of adjustability. The mirrors 50 and 52 are normally adjusted as the driver enters the vehicle to have a reflective sight vector parallel to the central axis X along side the vehicle. Mounted at the rearmost edge of the side panels of the vehicle 10, are a left rear view mirror 54 and a right rear view mirror 56. Mirrors 54 and 56 are in front to rear alignment with mirrors 50 and 52 but are beyond the rear of the vehicle, so as to be able to “see” laterally exterior. The mirrors 54 and 56 are also aligned parallel to the transverse axis Y, so that they have a complex intersection of sigh lines. Preferably, the left rear view mirror 54 is planar while the right rear view mirror 56 is concave. Thus, by adjusting the mirrors 64 and 66, a wider than normal view of both sides of the vehicle is obtained.

A wide variety of mirrors can be used in each of the mirror assembly as shown and many different mirrors are commercially available. Such mirrors as planar, concave or convex mirror, mirrors, enlarging or reducing mirrors can be effectively used as those skilled in this art know.

It will also be apparent that the system can be adapted for use on foreign made vehicles when the driver is on the right side of the body and the vehicle is driven on the right side of the road. This adaption would necessitate exchange of the right and left mirror assemblies and mirrors. If special mirrors are used, they should be designed to accommodate sight lines from the opposite sides described above. Sensors, such as video cameras, laser assemblies, RF detectors and the like may replace the mirrors without any difficulties or under experimentation, so long as they produce the desired sight lines.

The mirrors may be mounted to be fully visible or partially or fully concealed within the body and when needed remotely placed into position. It is preferable, however, that where the vehicle is operated and in movement, the mirrors be fully extended and in use. In this way, the driver has immediate use of enhancing systems.

1. A system for enhancing the view of a driver while driving a vehicle, said vehicle having a longitudinal axis, and a front transverse axis and a rear transverse axis, said system comprising a selectably adjustable mirror mounted, in each of the extreme sides of said vehicle, said mirrors having sight-lines parallel to said front transverse axis, said sight lines extending beyond the side exterior of said vehicle and means for selectively adjusting said mirrors so as to provide sight perspectives between said aligned mirrors at the sides of the front end of said vehicle, said V-shaped mirror assembly and said driver whereby said driver is provided with an enhanced exterior view while driving, capable of viewing the area ahead of and beyond the sides of said vehicle

2. An optical system for enhancing the view of a driver while driving a vehicle having a longitudinal axis, and a front transverse axis and a rear transverse axis, said system comprising an adjustable V-shaped mirror assembly mounted on the front end of the vehicle along the central axis of the vehicle, the apex of said V-shaped mirror assembly being pointed substantially rearwardly along the central axis, a selactably adjustable mirror mounted, in alignment with said V-shaped mirror assembly, on each of the extreme sides of said vehicle, said mirrors having sight-paths parallel to said front transverse axis, said sight paths extending beyond the exterior of said vehicle and means for selectively adjusting said mirrors so as to provide vectors of reflection between said aligned mirrors at the sides of the front end of said vehicle, said V-shaped mirror assembly and said driver whereby said driver is provided with an enhanced exterior view while driving, capable of viewing the area ahead of and beyond the sides of said vehicle

3. The system according to claim 1 or 2, wherein the mirror adjustment means are a remote control positioned in ate vehicle.

4. The system according to claim 1 or 2, wherein at least one of the mirrors at the front end of said vehicle has an arcuate face for increased sight path.

5. The system according to claim 4, wherein said arcuate mirror is parabolic.

6. The system according to claim 4, wherein said arcuate mirror is convex.

7. The system according to claim 1 or 2, including a rear view mirror assembly for selectively obtaining sight lines to the rear of and side exterior at the rear of said vehicle.

8. The system according to claim 7, wherein said rear mirror assembly comprises an adjustable mirror located on the side of said vehicle slightly ahead of said driver having a sight line substantially perpendicular to said longitudinal axis and mirror located at the extreme rear end of said vehicle intersection of said sight path and being selectively adjustable to have a second sight path viewing the exterior area of said vehicle, said mirrors having reflective perspectives to said driver whereby said driver can view the exterior of said vehicle perpendicular to said longitudinal axis.

9. The system according to claim 8, wherein at least one of said mirrors at the rear of said vehicle has an arcuate face.

10. The system according to claim 9, wherein said arcuate mirror is parabolic.

11. The system according to claim 9, wherein said arcuate mirror is convex.
